(19) United States
(12) Patent Application Publication
(10) Pub. No.: US 2022/0075960 A1
(43) Pub. Date: Mar. 10, 2022

(54) Interactive Communication System with Natural Language Adaptive Components

(71) Applicant: Achieve Intelligent Technologies, Inc., West Hollywood, CA (US)

(72) Inventors: William Brown, Los Angeles, CA (US); Wasiq Mamun, Los Angeles, CA (US); Shreya Gupta, Los Angeles, CA (US); Marti McElreath, Los Angeles, CA (US); Alexandra Lawn, Los Angeles, CA (US); Dylan Burris, Los Angeles, CA (US); Garrett Serwatka, Houston, TX (US)

(21) Appl. No.: 17/471,081

(22) Filed: Sep. 9, 2021

Related U.S. Application Data
(60) Provisional application No. 63/076,046, filed on Sep. 9, 2020.

(51) Int. Cl. G06F 40/35; G06F 40/186; G06F 40/40; G06F 40/289; H04L 12/58

(52) U.S. Cl. CPC G06F 40/35; G06F 40/186; H04L 51/02; G06F 40/289; G06F 40/40

(57) ABSTRACT

Methods and systems are provided for personalizing a free-form communicative system. The free-from communicative system allows a service provider to autonomously communicate with a user. The free-form communicative system may use an adaptive communicative application and natural language adaptive components to interact with the user. The communicative system may be configured to receive an inbound message from the user and maintain a conversation with the user in their own natural language. The communicative system may assess the inbound message and generate labels, packages, and blueprint objects related to the input message. The communicative system may generate personalized sentences based on the respective labels, packages, and blueprint objects as well as message templates. In response to the input message, the communicative system sends the personalized sentences as an output message to the user, where the personalized sentences are commensurate to the conversation and natural language of the user.

### PRIORITY

This application claims the benefit of and priority to U.S. Provisional Application No. 63/076,046, filed Sep. 9, 2020, which is incorporated in its entirety herein.

### FIELD

The embodiments of the present disclosure relate to interactive systems. More particularly, the embodiments relate to a personalized free-form communicative system with adaptive communicative applications and natural language adaptive components.

### BACKGROUND

Interactive systems were created to help users exchange information with service providers through customer service/sales representatives and call centers. With the emergence of the Internet and its accessibility to the public, interactive systems have emerged for service providers to better communicate with their users. These new interactive systems may comprise web-based informational systems, web-based form ticketing systems, and chatbots.

Automated chatbots are a technology widely used in lieu of customer service or sales representatives, sales representatives, call center representatives, or customer relationship management (CRM) components. Alternatively, automated chatbots are also often used as pre-processing components to help service providers filter and select which particular service representatives may best address the particular issues of the users. For example, if an automated chatbot is not capable of directly addressing a particular issue for a user, the automated chatbot is configured to subsequently act as an informational filter for a service provider by reducing the overall customer service time for the user.

Additionally, some recent chatbots may be capable of handling authentic human language input with the use of artificial intelligence (AI) and Natural Language Processing (NLP) algorithms. These chatbots typically use the input to typically direct the users into a predetermined conversational flow, for example, a set of predetermined questions and scenarios that invoke binary “yes” or “no” responses from users. However, these predetermined questions and scenarios are often rigid and form controlling user experiences as users are thwarted from having unstructured and natural conversations with these chatbots- or any control of the conversations themselves. For example, when user responses prompt any deviations from predetermined conversational flows, these recent chatbots have extreme difficulty handling such deviations and are consequently unable to continue operating and providing any assistance to the users. This results in users getting frustrated and prematurely ending their chatbot conversations, while their issues still remain unsolved and, most likely, may require multiple conversations to be resolved.

Alternatively, other existing technologies do not utilize predetermined communicative paths and thus provide limited or no scalability and control over the conversation as a whole. For example, these existing technologies rely solely on keyword detection and word embedding models such as Word2Vec and/or GloVe, which generally convert the input message into an array of vectors and is then compared to data that has been collected in a knowledge base. Thereafter, such technologies aim at generating output messages by providing words based on statistical probabilities. However, there is no current way to explain why these technologies output these specific output messages and strings that typically vary widely and are not very reliable. Furthermore, there is generally no viable option to do a retrospective analysis or improve the intelligence of these models as a whole without entirely retraining such models and risking losing intelligent handling and data in another sector due to the risks involved with making updates, and the delicate nature of the statistical probabilities derived from the ambiguity of language.

### BRIEF DESCRIPTION OF DRAWINGS

The above, and other, aspects, features, and advantages of several embodiments of the present disclosure will be more apparent from the following description as presented in conjunction with the following several figures of the drawings. The drawings refer to embodiments of the present disclosure in which:

FIG. 1 illustrates an exemplary diagram of a free-form communicative system with a communicative computing device, in accordance with an embodiment of the disclosure;

FIG. 2 illustrates a simplified schematic diagram of a communicative system with a communicative computing device, in accordance with an embodiment of the disclosure;

FIG. 3 illustrates a process for personalizing a free-form communicative system with natural language adaptive components, in accordance with an embodiment of the disclosure;

FIG. 4 illustrates a detailed schematic diagram of a communicative system with a communicative computing device, in accordance with an embodiment of the disclosure;

FIGS. 5A-D illustrate a series of exemplary diagrams of an adaptive communicative system with an adaptive communication application, which includes a read engine, a processing unit, an interpreter engine, and a generation engine, in accordance with embodiments of the disclosure;

FIG. 6 illustrates a diagram of a distributed communicative system, in accordance with an embodiment of the disclosure; and

FIG. 7 illustrates a schematic diagram of a computing system which may be used in accordance with one or more embodiments of the disclosure.

### DETAILED DESCRIPTION

The embodiments described herein relate to systems and related methods for personalizing a free-form communicative system with adaptive communicative applications and natural language adaptive components. As described in greater detail below, embodiments may allow a service provider (e.g., a company) to autonomously communicate with a user (e.g., a customer) through an adaptive communicative application and natural language adaptive components. Embodiments enable the user to send an input message (e.g., with one or more questions) in their own natural language to initiate a conversation with the service provider. Furthermore, the embodiments of the free-form communicative system provide various communicative tools that facilitate predetermined conversational pathways for the users via a combination of templates, components, policies, policy sets, message component sets, and/or general settings. For most embodiments, these conversation pathways may ensure the service provider's goals are met during the conversation, while allowing for real-time dynamic conversational path modifications, such that each conversation is unique and the user's natural self-expression is preserved.

Moreover, the embodiments described herein enable a customer (e.g., a service provider, a client, a user, an electronic device such as an automated personal assistant device, etc.) to personalize the free-form communicative system to have control over the outbound messages, while also being considerate of the inbound messages and a user's freedom of self-expression to communicate in their own natural language. For example, in these embodiments, the free-form communicative system may be implemented as an autonomous interactive communicative system that may receive inbound messages from the user in the user's natural language, and thereby generate outbound messages with personalized sentences that are commensurate to the conversation and natural language of the user. Accordingly, in most embodiments, the free-form communicative system (or autonomous interactive communicative system) described herein may be implemented by, but not limited to, service providers (e.g., a customer representative, a sales representative, a call center, a company's automated concierge, etc.), home personal assistants and devices, work personal assistants and devices, smart electronic devices (e.g., a smart home sensor/camera, a smart watch, a smart speaker, etc.), communication interfaces for intra-company communications, online conversational product or service recommendation engine, conversational surveys, conversational feedback systems, personal learning assistants, personal assistant for reminders and accountability, conversational interactions between consumers and software applications (e.g., conversational interactive applications, etc.), conversational interactions between consumers and hardware installations (e.g., kiosks, etc.), and/or any other similar service providers, systems, devices, and/or applications.

Furthermore, the embodiments described herein provide various technological improvements by: (i) enabling the service provider to control how the conversation is designed; and (ii) facilitating the virtual conversational agent with a degree of self-awareness as related to knowing its goals in its conversation and having the ability to manage a variety of skills (e.g., these skills may extend from answering questions to handling objections, allowing the user to correct typos in real-time, and so on). Additionally, the embodiments may help service providers to substantially reduce their costs of maintaining a quality customer service. Embodiments also enable service providers to recognize and cluster issues that large numbers of users may be experiencing in real-time sooner and thus solve the issues quicker than other service providers, which may be reliant on people or systems that need to listen to transcribed conversations to identify any issues. In some embodiments, the service providers may also engage with their prospective users autonomously via web-based chats, text messages, and voice (or voice messages) to reduce the cost of user acquisition and thereby improve the overall user experience from start to end. Finally, the embodiments may enable communicative systems to be free from any predetermined flows (or control) after enough time and accumulation of user/service provider data has been reached (i.e., after one or more time and data thresholds have been surpassed, as specified by the service provider), which substantially improves the existing interactive systems by servicing the needs of users better than any experienced representative, inside sales agents, and chatbots.

Aspects of the present disclosure may be embodied as an apparatus, system, method, and/or computer program/application product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data may include the entirety of the data, a portion of the data, a set of the data, and/or a subset of the data. Likewise, reference to reading, writing, storing, buffering, and/or transferring non-host data may include the entirety of the non-host data, a portion of the non-host data, a set of the non-host data, and/or a subset of the non-host data.

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program/application products according to embodiments of the disclosure. It will be understood that each block of the schematic flowchart diagrams and/or schematic block diagrams, and combinations of blocks in the schematic flowchart diagrams and/or schematic block diagrams, may be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Although embodiments herein may be described and illustrated in terms of a communicative system and communicative components, it should be understood that embodiments may include any systems, methods, components, devices, and/or computer program/application products configured to autonomously communicate and interact in real-time (e.g., assuming any networking and processing latencies, etc.) with linguistically-informed artificial intelligence (AI), natural language algorithms (e.g., Natural Language Understanding (NLU), Natural Language Processing (NLP), Natural Language Generation (NLG), etc.), personalized service provider interactive or customer service protocols, policies, etc., and/or any other non-limiting combinations thereof.

Also, although embodiments of the present disclosure may be described and illustrated herein in terms of a free-form communicative system, it should be understood that embodiments of this present disclosure are not limited to the systems illustrated below or any particular configuration(s) of such systems, but rather may include a wide variety of interactive systems, components, or services, including client devices, call centers (or third-party devices), quality assurance systems, cluster(s) of mobile devices (e.g., cluster of user devices), various databases (e.g., multiple databases associated with various natural language questions/answers, personalized service providers (or clients, users, etc.), and so on), and/or any other interactive systems or components, that provide an improved interactive and communicative service to a user in accordance with the embodiments of the present disclosure. Moreover, embodiments as described herein are not limited to use as free-form communicative systems, but rather may have applicability in other communicative systems in which service providers (or the like) necessitate improved interactive and communicative services to interact and communicate with users in their respective natural languages without having to revert to any binary answer selections.

As used herein, a personalized response (or personalized sentence, sequence of words, etc.) may refer to a natural language response: (i) that is contextually, informationally, and grammatically correct based on an input message of a user's natural language, (ii) that moves the conversation forward in a specified direction based on a service provider's customer service protocols, policies, and so on whilst the user has the capability to alter the specified direction of the respective conversation, and (iii) that communicates empathetically and serves an actionable purpose for both the service provider and the user (e.g., actionable purposes such as servicing and answering any of the user's questions so that the user may continue to use the services (or products) of the service provider).

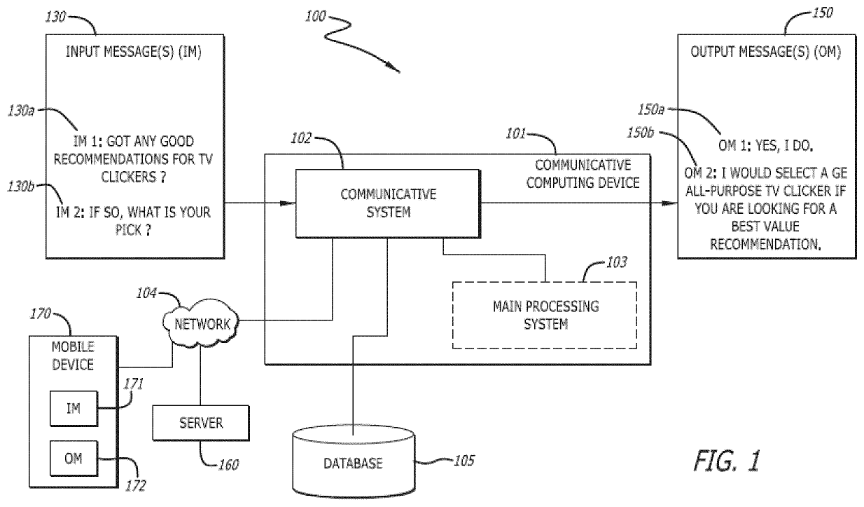

Referring now to FIG. 1, an exemplary diagram of a free-form communicative system 100 with a communicative computing device 101 is shown, in accordance with an embodiment of the disclosure. Embodiments of the free-form communicative system 100 may include, but are not limited to, a mobile device 170, a network 104, a server 160, an input message(s) (IM) 130, and an output message(s) (OM) 150. Additionally, embodiments of the communicative computing device 101 may include a communicative system 102 and a main processing system 103. The free-form communicative system 100 may use the communicative computing device 101 to receive and assess the IMs 130. Likewise, the free-form communicative system 100 may use the communicative computing device 101 to generate and send the output message 150 based on the corresponding input message 130. Although only one communicative system 102, one main processing system 103, and one database 105 are shown, it should be understood that any number of communicative systems 102, main processing systems 103, and databases 105 may be used with the free-form communicative system 100 or the communicative computing device 101, without limitation. Moreover, the exact configuration of the one or more communicative systems 102, main processing systems 103, and databases 105 may be varied without limitation.

As described herein, the embodiments depicted in FIG. 1 (or any of the other figures illustrated below) may be implemented by the communicative computing device 101, or by a device (e.g., the mobile device 170) that provides the IM 130 to the communicative computing device 101 and receives the OM 150 from the communicative computing device 101.

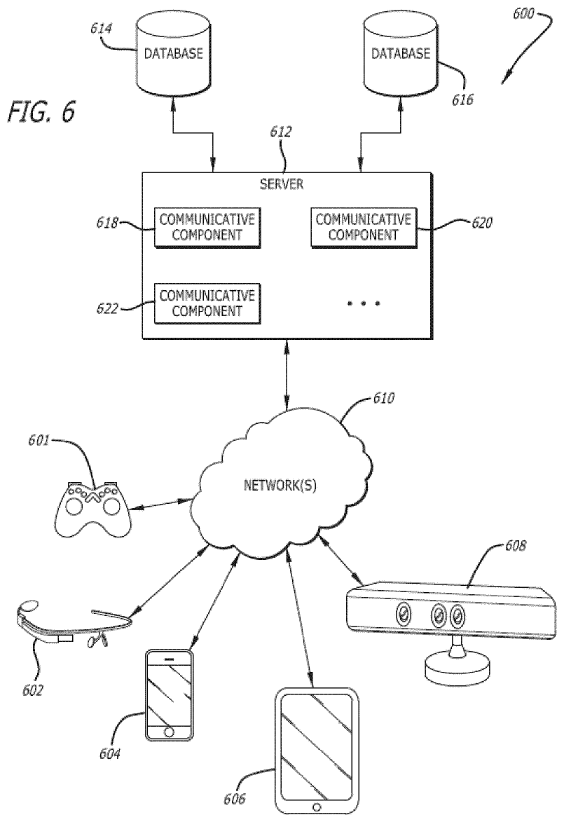

The mobile device 170 may be, but is not limited to, a mobile device, a user device, a consumer device, a customer device, and so on. The mobile device 170 may be implemented with (or similar) to the computing system 600 described below in reference to FIG. 6. The mobile device 170 may comprise any type of computing device capable of use by a user. In some embodiments, the mobile device 170 may comprise a personal computer (PC), a laptop computer, a mobile device, a smartphone, a tablet computer, a smart watch, a wearable computer, a fitness tracker, a virtual reality headset, augmented reality glasses, a personal digital assistant device (PDA), a global positioning system (GPS) device, a handheld communications device, a gaming device or system, a music player, a video player, an entertainment system, a vehicle computer system, an embedded system controller, a remote control, an appliance, a consumer electronic device, a workstation, or any combination of these type of computing devices, or any other suitable mobile computing device.

Additionally, the embodiments depicted herein in FIG. 1 may be implemented by the mobile device 170 with IM 171 and OM 172 that provides the IM 170 to the communicative computing device 101 and receives the OM 172 from the communicative computing device 101. The mobile device 170 may include one or more IMs 171 and one or more OMs 172. In some embodiments, the IMs and OMs 171-172 may be embodied as one or more communicative applications or one or more computer program/application products or services that operate in conjunction with the communicative computing device 101. In the particular illustrated embodiment in FIG. 1, the IMs and OMs 171-172 are depicted as components in the mobile device 170. In other embodiments, each of the IMs 171 and/or the OMs 172 may be embodied as a specifically designed hardware, a browser plug-in, a specifically designed computer program or application operating on a user device, across multiple devices, in the cloud, or a computing service running in the cloud, which may implement one or more embodiments described herein.

In embodiments, the mobile device 170 may communicate with the server 160 or the communicative computing device 101 over the network 104 to. For example, a user may use the mobile device 170 with the IMs and OMs 171-172 to communicate with the server 160 or communicative computing device 101. The mobile device 170 may send an IM 171 to the server 160 or the communicative computing device 101 over the network 104. In some embodiments, the server 160 may be used to direct the IM 171 from the mobile device 170 to the communicative computing device 101 over the network 104. The network 104 may be comprised of any public or private networks, wired or wireless networks, Wide Area Networks (WANs), Local Area Network (LANs), and/or the Internet. In embodiments, the communicative computing device 101 receives the IM 171, generates one or more personalized responses (or personalized sentences, words, etc.) based on the IM 171, and respectively sends the OM 172 with the personalized responses to the mobile device 170 over the network 104.

In general, embodiments described herein may use the communicative system 102 to answer one or more questions received via a chat or the like. In some embodiments, the chat may comprise any text chat such as text messages, SMS, Facebook Messenger, WhatsApp, online chatbot interfaces, or any other text chats; and any voice chats such as voice messages, FaceTime messages, dictated messages, or any other voice chats over a mobile device (or the like), when voice communicative capabilities are implemented.

As depicted in the embodiments shown in FIG. 1, the communicative system 102 receives the IM 130 which may include a single question, a sequence of questions, a combination of questions (or statements, issues, words, etc.), and/or the like. In embodiments, the communicative system 102 assess questions 130a-b from the IM 130 with the main processing system 103 to generate one or more respective tasks, which may be associated with the questions 130a-b of the IM 130. The tasks may comprise read tasks and generation tasks as described in further detail below. In embodiments, the read tasks may be related to actions implemented by the communicative system 102 that facilitate the progress of the conversation and aggregate information based on the IM 130. Likewise, in other embodiments, the generation tasks are actions implemented by the communicative system 102 that facilitate the progress of the conversation and generate information (e.g., personalized sentences) based on the OM 150. The read and generation tasks may be implemented with the communicative system 102, the main processing system 103, the database 105, the server 160, and/or any combination thereof. The main processing system 103 may include, but is not limited to, a read engine, a processing unit, and a generation engine, as described in further detail below. In embodiments, the database 105 may comprise any type of database which may include information (or data) associated with natural language questions/answers, conversations, customer service protocols, policies, etc., and/or any other similar information. Additionally, the server 160 may be a public or private server which may be configured to implement one or more of the embodiments described herein.

Accordingly, the communicative system 102 generates answers 150a-b based on the respective tasks and correspondingly sends the OM 150 with the answers 150a-b over the network 104. For example, as shown in FIG. 1, the communicative system 102 sends the answers 150a-b as the OM 150 that provides the illustrated texts “YES, I DO.” and “I WOULD SELECT A GE ALL-PURPOSE TV CLICKER IF YOU ARE LOOKING FOR A BEST-VALUE RECOMMENDATION.” as the natural language responses to the chat, which submitted the illustrated texts “GOT ANY RECOMMENDATIONS FOR TV CLICKERS?” and “IF SO, WHAT IS YOUR PICK?” as the questions 130a-b of the IM 130 based on the user's natural language. In the illustrated example, the communicative system 102 assessed the questions 130a-b of the IM 130 to determine that the text “TV CLICKER” may be associated with television remote controllers (or the like), and the following text “WHAT IS YOUR PICK” may be associated with providing an informed recommendation of the best television remote controllers.

Embodiments of the computer system 102 and main processing system 103 may be implemented as one or more communicative applications or one or more computer program/application products or services that may operate in conjunction with the communicative computing device 101. In embodiments, as shown in FIG. 1, each of the computer system 102 and the main processing system 103 is depicted as a component in the communicative computing device 101. In other embodiments, the computer system 102 or the main processing system 103 may be implemented as a specifically designed hardware, a browser plug-in, a specifically designed computer program or application operating on a user device, across multiple devices, in the cloud, or a computing service running in the cloud to implement one or more of the embodiments described. Although the communicative system 102 may be described in relation to chats (or chat systems), it should be understood that any interactive and/or communicative systems may be utilized, such as email systems, interactive webpages, text/voice/video call systems, and/or any other interactive messaging systems depending on the interactive environment of the free-form communicative system 100.

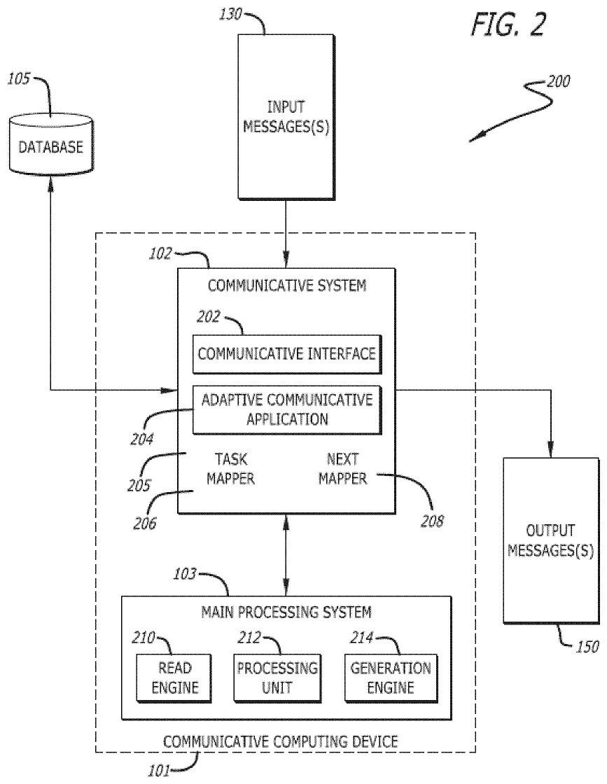

Referring now to FIG. 2, a simplified schematic diagram of a system 200 is shown, in accordance with embodiments of the disclosure. In embodiments, the system 200 may include a database 105, an IM 130, an OM 150, and a communicative computing device 101. In embodiments, the communicative computing device 101 may include a communicative system 102 and a main processing system 103. The communicative system 200 in FIG. 2 may be similar to the free-form communicative system 100 described above in FIG. 1. Likewise, the database 105, the IM 130, the OM 150, and the communicative computing device 101 with the communicative system 102 and the main processing system 103 in FIG. 2 may be substantially similar to the database 105, the IM 130, the OM 150, and the communicative computing device 101 with the communicative system 102 and the main processing system 103 described above in FIG. 1.

In some embodiments, the database 105 may be implemented to store any information provided by the communicative system 102. For example, the database 105 may store any information related to the IM 130, the OM 150, and/or any other similar interactive information, including personalized customer service protocols, policies, etc., and prior conversations between the communicative system 102 and the users. Although one database 105 is shown in connection with the communicative system 102, it should be understood that any number of databases 105 may be utilized, and that any particular configuration in relation to the database 105 and the communicative system 102 may be implemented, without limitation.

Embodiments of the communicative system 102 may include, but are not limited to, a communicative interface 202, an adaptive communicative application 204, and an interpretation engine 205 that may further include a task mapper 206 and/or next mapper 208. In general, the adaptive communicative application 204 may act as a centralized hub for the communicative system 102 which is configured to facilitate any of the frontend and/or backend sequences used to receive the IM 130 and send the OM 150. For example, the adaptive communicative application 204 may be configured to handle both frontend and backend sequences including, but are not limited to, one or more frontend sequences implemented with the communicative interface 202 to interact with the user (or the service provider, etc.), and one or more backend sequences used to call any components within the communicative system 102, the main processing system 103, the communicative computing device 101, the database 105, and/or any other components associated with the system 200. In some embodiments, the communicative interface 102 may be implemented to receive and send the IM and OM 130 and 150 and interact with the respective user, mobile device, service provider, or the like.

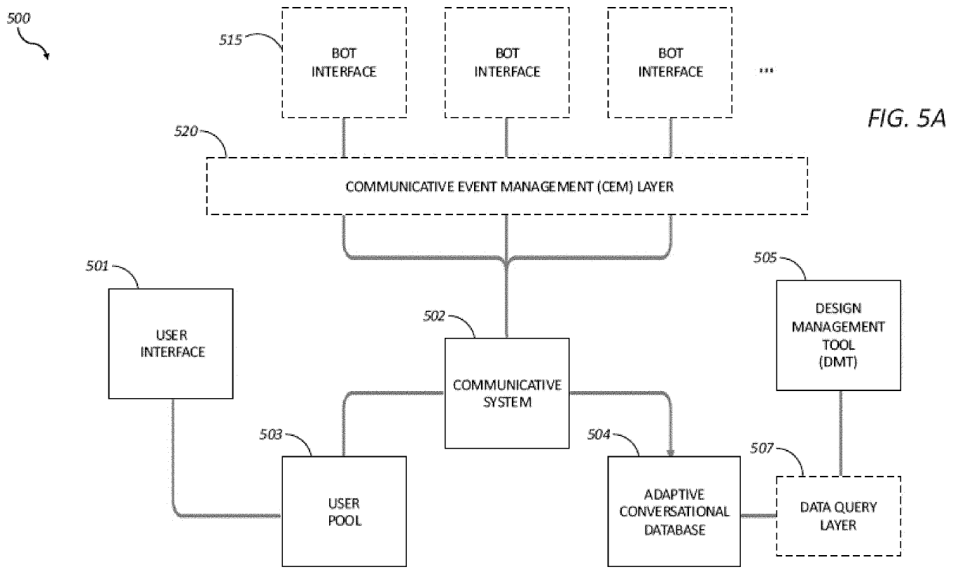

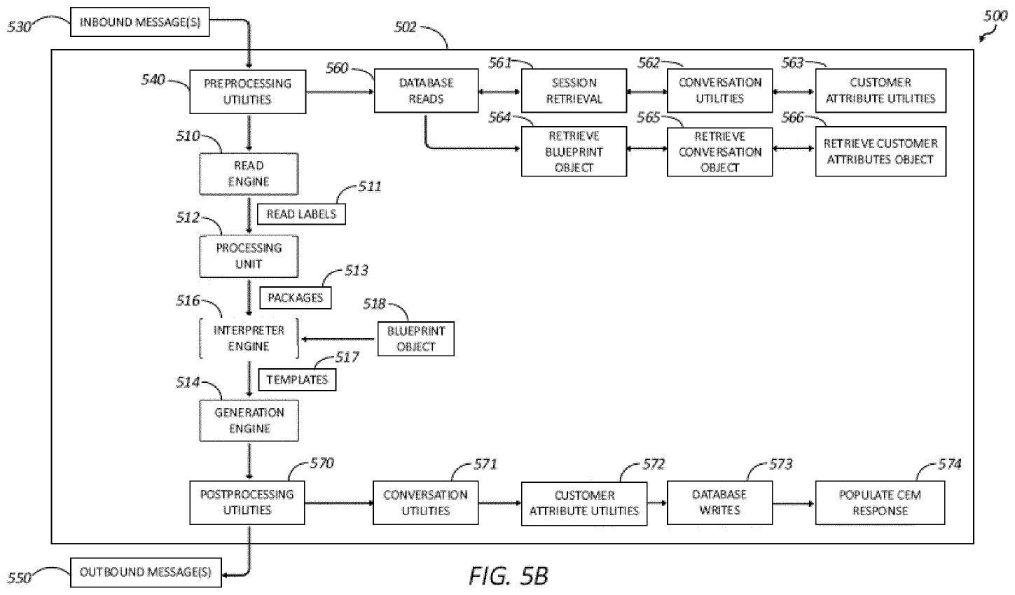

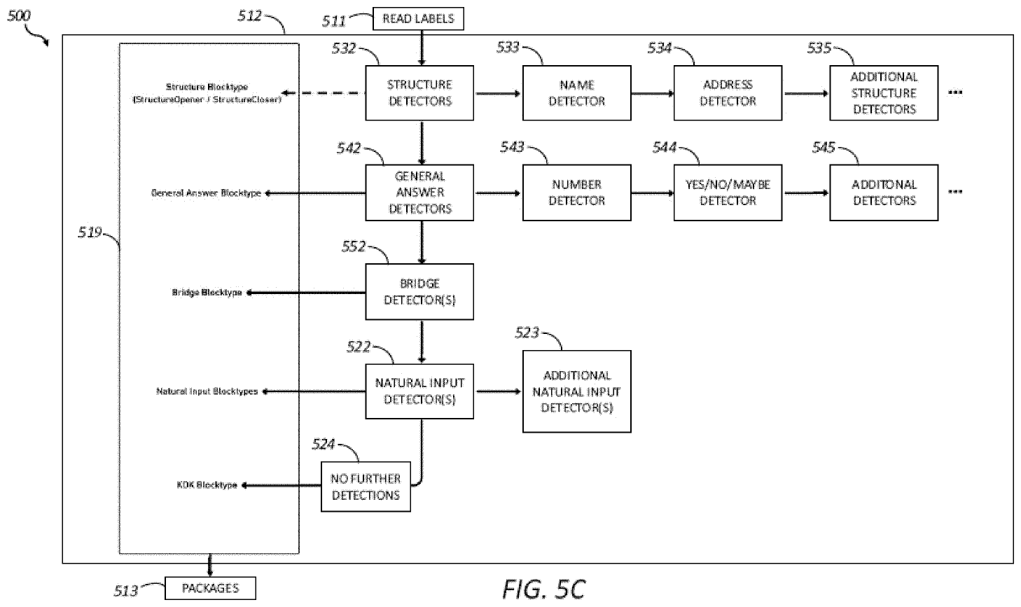

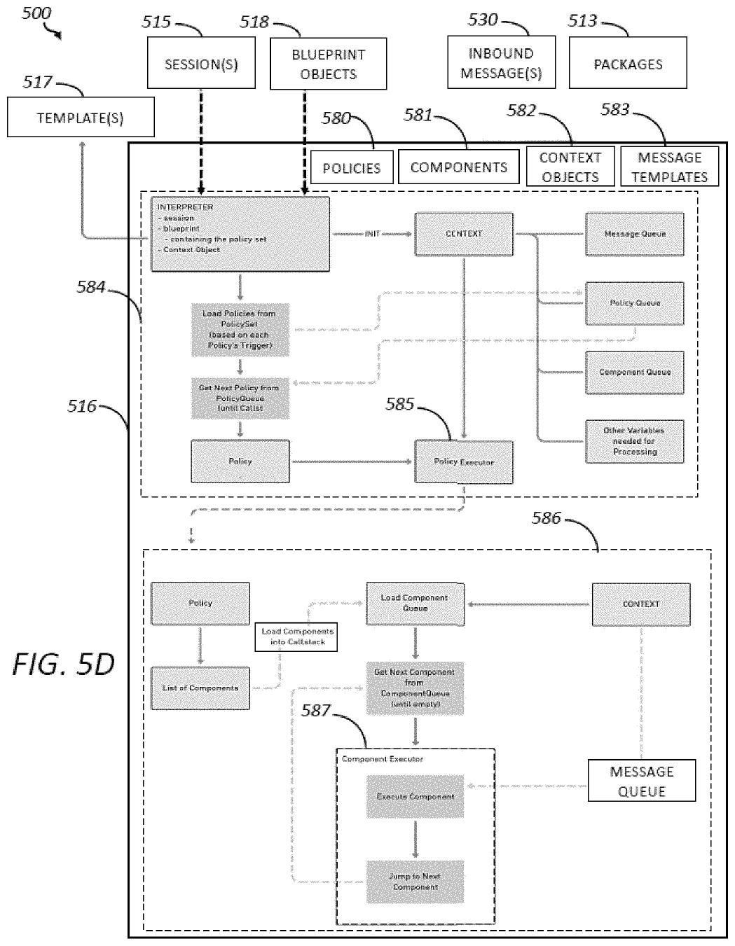

In most embodiments, the interpretation engine 205 may be configured to include one or more components that are configured to implement a set of instructions used to determine how to process and respond to a received inbound message. For example, the one or more components of the interpretation engine 205 may include, but are not limited to, task mapper(s), next mapper(s), policies, components, context objects, message templates, policy/component executors, and/or policy/component/message queues. That is, in some embodiments as shown in FIG. 2, the interpretation engine 205 may be configured with a task mapper 206 and/or next mapper 208. However, in other embodiments, the interpretation engine 205 may be configured similar to the interpretation engine 516 depicted in FIG. 5D, where the interpretation engine 516 may be configured with policies 580, components 581, context objects, message templates 583, policy executor 585, component executor 587, and so on. As such, although one task mapper 206 and one next mapper 208 are optionally depicted in FIG. 2, it should be understood that the interpretation engine 205 is not limited to the task/next mappers 206/208 and instead may be configured with any of these components described herein, without limitations.

In some embodiments, the task mapper 206 may be configured to facilitate one or more actions implemented by the adaptive communicative application 202 or any other backend data structures related to the IM 130. The task mapper 206 may be configured to generate one or more READ tasks, populate one or more data structures of a conversation ledger, and facilitate one or more pre-banked response checks. In some embodiments, the READ tasks may be one or more actions associated with one or more natural language definitions and rules. For example, the task mapper 206 may implement the READ tasks to populate one or more data structures of the conversation ledger, and trigger one or more specific messages caused by one or more specific changes to the data structures of the conversation ledger.

The conversation ledger may be used to maintain and control what has been said in any particular conversation, and what respective data structures have and have not been answered in any particular conversation. In some embodiments, the task mapper 206 may populate the conversation ledger based on one or more block-types generated by, for example, the processing unit 212. For example, the block-types may correspond directly to changes made to a conversation ledger as these changes are processed by the processing unit 212 and respectively updated in an updated conversation ledger by the task mapper 206.

Additionally, in some embodiments, the task mapper 206 may be configured to facilitate pre-banked response checks of any particular on-going conversation depending on how the conversation ledger is filled up. In these embodiments, the pre-banked response checks may facilitate one or more specified conditions established by, for example, the service provider (or the like). The conditions of the pre-banked response checks may trigger one or more specified pre-banked responses and direct the specified pre-banked responses to be sent as an OM to the user. In embodiments, the next mapper 208 may be configured to determine one or more next data structures based on the updated conversation ledger from the task mapper 206. The next mapper 208 may use the current data structures from the updated conversation ledger to determine and populate the next data structures, which may be used to generate the corresponding generation tasks that are processed and passed to the generation engine 214. Moreover, although only one communicative interface 202, one adaptive communicative application 204, one interpretation engine 205 with one task mapper 206 and one next mapper 208 are shown, it should be understood that any number of communicative interfaces 202, adaptive communicative applications 204, interpretation engines 205, task mappers 206, next mappers 208, and/or other communicative components may be implemented with the communicative system 102, without limitation.

The embodiments of the main processing system 103 may include, but are not limited to, a read engine 210, a processing unit 212, and a generation engine 214. Moreover, although only one read engine 210, one processing unit 212, and one generation engine 214 are shown in the main processing system 103, it should be understood that any number of read engines 210, processing units 212, generation engines 214, and/or other processing components may be implemented with the main processing system 103, without limitation. The read engine 210 may be configured to read the IM 130 and access, extract, and identify one or more sentences, texts, and/or labels associated with the IM 130. The read engine 210 may also implement one or more natural language (or linguistic) rules and grammatical parsers to classify the IM 130. For example, the read engine 210 accesses the IM 130 to establish a set of labels. The set of labels may include, but are not limited to, person labels, object labels, sentence type labels, timescope labels, and action labels (POSTA labels).

Sentence type labels are used to classify the text (or sentences) in the IM 130 as either a declarative, imperative, interrogative, or exclamatory type of sentences. Timescope labels are used to classify the IM 130 into two or more parts: the tense (i.e., whether the sentence tense is in present, past, or future tense), and the aspect (i.e., whether the sentence aspect is in simple, perfect, progressive, or perfect progressive aspect). Person labels comprise whether the IM 130 is in the first, second, or third person, and whether the respective person(s) of the IM 130 is singular or plural. Action labels may mark each action, or verb, in the IM 130 and relate each action/verb with their appropriate person, timescope, and subject. For example, a sentence “I want to sell my house” may have two actions: “want” and “sell”, and each of the actions of the sentence may have its own set of timescope, person, and subject labels (e.g., present simple, first person, and “I” for both). Object labels may be used to take the one or more actions from the action labels and lists the one or more objects for each action. For example, the sentence “I want to sell my house” may establish that the action “want” would have no object, while the action “sell” would have “my house” marked as a direct object.

Additionally, the read engine 210 may be configured to generate one or more constituency trees and/or dependency trees. Constituency trees may depict how a sentence is broken down into its grammatical components which are typically known as syntactic constituents. Some examples of constituents are nouns, verbs, and adjectives, which are referred to as terminal nodes. The constituency tree may also depict one or more non-terminal nodes. For example, the non-terminal nodes may identify a noun phrase (or the like) which comprises a noun and one or more other elements. Furthermore, the information of the constituency trees may help to identify the syntactic functions of any word in any sentence in a hierarchical fashion.

Meanwhile, the dependency trees may be implemented to identify the relationship between any words in any sentence. For example, a verb phrase may comprise a “head” (verb) which may be related to one or more other elements, such as adverbs, objects, or the like. The dependency trees may also provide one or more verification tools capable of identifying whether the related elements are grouped into the same category, regardless of the order the related elements may appear in the sentence. Additionally, the read engine 210 may implement one or more semantic role labelers to answer important questions about the predicate structure(s) of a sentence. Predicate structures help to extract the important components of sentences and their respective meaning, including, for example, who performed an action, who benefitted from the action, and so on.

The processing unit 212 may be a processing core (or the like) configured as a driver function of the main processing system 103, in accordance with some embodiments of the disclosure. For example, the processing unit 212 may process the IM 130 and the respective POSTA labels to determine one or more domain-specific meanings. The processing unit 212 may also help to determine how the IM 130 relates to the current conversation ledger and the domain information (e.g., the domain-specific meanings determined from the IM 130).

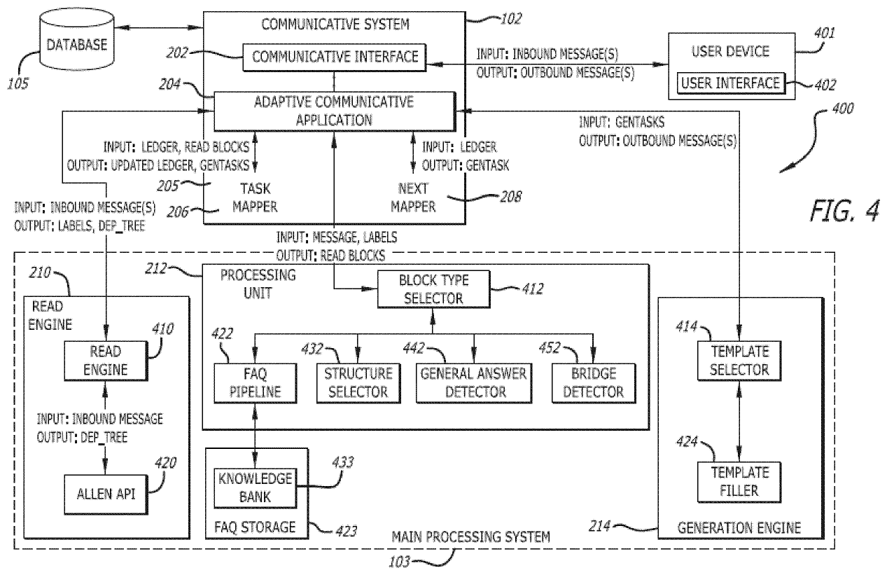

Furthermore, the processing unit 212 may comprise a sequence of one or more detectors (e.g., as described and illustrated in greater detail below with the sequence of components of the processing unit 212 in FIG. 4). The sequence of detectors may include at least one or more of a frequently asked questions (FAQ) pipeline, a structure selector, a general answer detector, and a bridge detector. For example, the processing unit 212 may use the sequence of detectors to generate a plurality of read-level blocks (or a plurality of block-types) that are based on the IM 130 and correspond to tasks implemented by the database 105, the communicative system 102, and/or the generation engine 214.

Embodiments of the generation engine 214 may be configured to receive the incoming generation tasks (or generation task values). The generation engine 214 may include a template selector and a template filler (e.g., as shown below in greater detail in FIG. 4). In some embodiments, the generation engine 214 may be used to sort through all of the templates of the template selector and return only those templates that satisfy the requirements the generation tasks. In the embodiments, the generation engine 214 may select one of the templates and respectively use the template filler to dynamically populate (or fill) the selected template with information gathered from the generation tasks and the structure-specific information. For example, the populated template may comprise a string of personalized sentences (or texts) that are directed to the communicative system 102. In embodiments, the communicative system 102 may receive the personalized sentences from the generation engine 214 and send the OM 150 with the personalized sentences as the natural language response(s) to the IM 130.

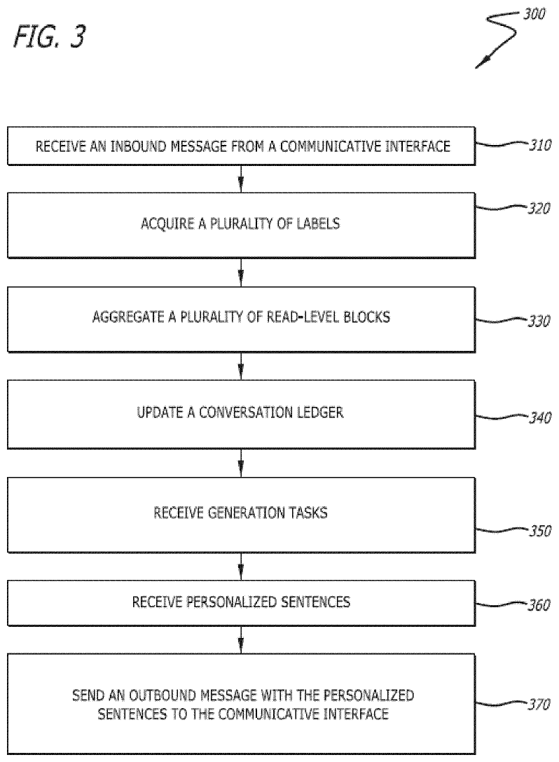

Referring in now to FIG. 3, an exemplary process 300 for personalizing a free-form communicative system is shown, in accordance with an embodiment of the disclosure. The process 300 may be depicted as a flow diagram used to personalize the free-form communicative system. The process 300 may be implemented with one or more computing devices or systems (e.g., the communicative computing device 101 in FIG. 1, the computing system 600 in FIG. 6, and/or any combination of devices and systems of the computing system 600 in FIG. 6). In some embodiments, the process 300 may be performed (or carried out) in one or more communicative systems, including, but are not limited to, the free-form communicative system 100 of FIG. 1, the system 200 of FIG. 2, the system of FIG. 4, and the distributed system 500 of FIG. 5.

At block 310, the process 300 may receive an inbound message from a communicative interface. At block 320, the process 300 may acquire a plurality of labels (e.g., POSTA labels) from a read engine. In embodiments, the plurality of POSTA labels may be associated with the inbound message and one or more constituency and dependency trees. At block 330, the process 300 may aggregate a plurality of read-level blocks from a processing unit. For example, the processing unit may generate the plurality of read-level blocks based on the inbound message, the plurality of POSTA labels, and the one or more constituency and dependency trees.

At block 340, the process 300 may update a conversation ledger in a task mapper. In embodiments, the task mapper may generate one or more first-generations tasks based on the plurality of read-level blocks and the inbound message. At block 350, the process 300 may receive generation tasks from a next mapper. In addition, the next mapper and/or the task mapper may generate one or more second-generation tasks based on a second inbound message and/or the updated conversation ledger. In embodiments, the generation tasks may be a third-generation tasks comprised of a combination of both the first- and second-generation tasks, and/or comprised of only the first-generation or second-generations tasks.

At block 360, the process 300 may receive one or more personalized sentences from a generation engine. In embodiments, the one or more personalized sentences may be generated based on the plurality of generation tasks and the plurality of POSTA labels. In addition, the personalized sentences may be implemented with a template which includes information populated from the plurality of generation tasks and POSTA labels. At block 370, the process 300 may send an outbound message with the personalized sentences to the communicative interface. For example, the personalized sentences of the outbound message may be generated based on the natural language associated with the inbound message. In embodiments, a communicative system may send the outbound message with the personalized sentences and the updated (or final) conversation ledger to be stored in a database. Additionally, the process 300 may be described and illustrated in further detail below in relation to the system 400 in FIG. 4.

Referring now to FIG. 4, a detailed schematic diagram of a system 400 is shown, in accordance with embodiments of the disclosure. In embodiments, the system 400 may include a database 105, a user device 401 with a user interface 402, a communicative system 102, and a main processing system 103. In embodiments, the communicative system 102 may include a communicative interface 202, an adaptive communicative application 204, and an interpretation engine 205 that may further include a task mapper 206 and/or next mapper 208. In embodiments, the main processing system 103 may include a read engine 210, a processing unit 212, and a generation engine 214. Embodiments may further include the read engine 210 with a read engine 410 and an ALLEN API 420; the processing unit 212 with a block type selector 412, a FAQ pipeline 422, a structure selector 432, a general answer detector 442, a bridge detector 452, and a FAQ storage 423 with knowledge bank 433; and the generation engine 214 with a template selector 414 and a template filler 424.

The communicative system 400 in FIG. 4 may be similar to the free-form communicative system 100 and the system 200 described above in FIGS. 1 and 2. For example, the database 105, the communicative system 102 with the communicative interface 202, adaptive communicative application 204, and interpretation engine 205 with the task mapper 206 and/or next mapper 208, and the main processing system 103 with the read engine 210, processing unit 212, and generation engine 214 in FIG. 4 may be substantially similar to the database 105, the communicative system 102 with the communicative interface 202, adaptive communicative application 204, and interpretation engine 205 with the task mapper 206 and/or next mapper 208, and the main processing system 103 with the read engine 210, processing unit 212, and generation engine 214 described above in FIG. 2. Also, for example, the user device 401 with the user interface 402 may be similar to the mobile device 170 with the IM/OM 130/150 described above in FIG. 1.

In embodiments, the read engine 210 may implement the read engine 410 (i.e., the internal read module, component, or the like) to read an inbound message received from the user device 401 and to generate a plurality of POSTA labels in relation to the inbound message. Additionally, the ALLEN API 420 may be used by the read engine 210 to generate one or more constituency and dependency trees as described above.

Furthermore, embodiments of the processing unit 212 may implement the block type selector 412 to determine and generate a plurality of read-level blocks (or data block-types) based on the inbound message, the POSTA labels, and/or any read and generation tasks that may have been generated. In some embodiments, the block type selector 412 may be implemented as the driver function that selects, detects, and generates the read-level blocks based on the FAQ pipeline 422, the structure selector 432, the general answer detector 442, the bridge detector 452, and the FAQ storage 423 with knowledge bank 433. The block-type selector 412 may also be used to determine the domain-specific meaning of the inbound message, how the inbound message relates to the conversation ledger, the domain knowledge, etc., and so on.

In embodiments, the structure selector 432 may be configured to maintain different components of information (and their respective structures) which may be in need of answers. The structure selector 432 may implement a set of rules through which the inbound message (and POSTA labels) are passed. Furthermore, the rules help the processing unit 212 to determine whether the content of the inbound message is related to any of the respective structures. The rules may include, but are not limited to, action rules, address rules, timeframe rules, names rules, and prices rules. For example, the action rules may assess texts “House to sell” to identify one or more actions related to “sell” and search to see if there are any property-related words in the object label. If so, this action rule is checked for negativity to determine whether the user has a house to sell.

Additionally, the address rule may comprise custom-made functions and open source libraries which may be used to search for address patterns in the inbound message and to split up the detected patterns for a street number, a street name, a unit, a city, a state, and a zip code. The timeframe rule may be implemented to detect various important time-related words in the inbound message, while proprietary functions search the surrounding words to include any that are directly related to the timeframe object. The name rules may be used to detect sentences with words similar to “My name is” or “I am” in combination with proper nouns, and to also identify expressions in which specific names are explicitly given. In some embodiments, a secondary name detector may be activated when the current conversation topic is “name.” The secondary name detector may use a combination of open source name-detection libraries and proper noun detection functions to thereby determine whether any of the words in the inbound message is a name, and, if it is, whether the detected word is a first or last name. The price rule may use a combination of regular expressions and keyword detections with surrounding-word analysis to identify a wide range of money-related expressions (e.g., sentences which include “$500”, “USD 3400” and “35 mil”).

In embodiments, the general answer detector 442 may be used to run sentences (or words, texts, etc.) through the one or more word detections, such as number detection, a Yes/No/Maybe detection, and an IDK detection. The number detection may detect any incoming message that includes a raw number, whether it is numeric or written out, and/or whether it is detected using parts of the sentence. The Yes/No/Maybe detection may detect a list of yes, no, and maybe words that are then compared against the other words in various manners to detect whether a sentence is answering a question with a yes, a no, or a maybe. Meanwhile, the IDK detection may be used to detect “know” action words detected in the sentence and then run through a series of functions, where the functions analyze the surrounding words to see if the core message or sentence is that the user does or does not know something.

In embodiments, the bridge detector 452 may be used handle inbound messages that are not about any conversation-level content or topics rather these messages are used as in between messages to provide conversational flow. For example, the bridge detector 452 may implement one or more bridge detections, including, but are not limited to, a greeting detection, a closer detection, and a transition detection. The greeting detection may be used to detect a list of greeting words and determine whether the inbound sentence is a greeting. The closer detection may be used to detect a list of conversation-ending words and determine whether the inbound sentence of the message is a closer. Alternatively, the transition detection may be used to detect a list of transition words and determine whether the inbound message is being said to transition in between conversation topics.

In embodiments, the FAQ pipeline 422 may implement one or more similarity models. For example, a similarity model may include a process flow that requests sent to (in order or any other personalized order): (1) input message through pre-processing; (2) iterate through every question in the knowledge bank (KB) 433 of the FAQ storage 423; (3) preprocess the KB questions; (4) get glove embedding for the edited sentences and questions; (5) run, for example, Word Mover's Distance algorithm to get the distance between the input message and the question in the KB; (6) find the question in KB that is closest to the input message; (7) if the distance corresponding to this question is below a certain threshold distance, return this question; (8) if not, return “question not found”; and (9), once the question is obtained, send the question to the generation engine 214 to map the question to the correct answer.

Embodiments of the generation engine 214 may be configured to receive the incoming the POSTA labels along with the generation tasks based on the read-level blocks and the conversation ledger. The generation engine 214 may include the template selector 414 and the template filler 424. In some embodiments, the generation engine 214 may be used to sort through all of the templates of the template selector 414 and return only those templates that satisfy the requirements the generation tasks. For example, the template selector 414 may then select a random template from the returned templates and pass the selected template to the template filler 424. In the embodiments, the template filler 424 may be used to dynamically populate the selected template with information gathered from the generation tasks and the structure-specific information. For example, the template filler 424 may create one or more personalized sentences based on the populated/filled template that are respectively sent to the adaptive communicative application 204. Finally, the adaptive communicative application 204 may use the personalized sentences from the generation engine 214 and sends the outbound message with the personalized sentences to the user device 401, where the personalized sentences of the outbound message are corresponding with the natural language of the respective inbound message of the user device 401.

Referring now to FIGS. 5A-D, a series of exemplary diagrams of an adaptive communicative system 500 are shown, in accordance with embodiments of the disclosure. In particular, referring now to FIG. 5A, an exemplary block diagram of the adaptive communicative system 500 is shown, in accordance with an embodiment of the disclosure. In most embodiments, the adaptive communicative system 500 may include at least one or more of a user interface 501, a communicative system 502, a user pool 503, an adaptive conversational database 504, a design management tool (DMT) 505, a data query layer 507, one or more bot interfaces 515 (or devices, plug-ins, etc.), and a communicative event management (CEM) layer 520. In many embodiments, the adaptive communicative system 500 depicted in FIGS. 5A-D may be similar to the free-form communicative system 100 depicted in FIG. 1, the free-form communicative system 200 depicted in FIG. 2, and/or the free-form communicative system 400 depicted in FIG. 4. Similarly, in most embodiments, the communicative system 502 depicted in FIG. 5A may be similar to the communicative system 102 depicted above in FIGS. 1, 2, and 4. As such, it should also be understood that the adaptive communicative system 500 in conjunction with the communicative system 502 depicted in FIG. 5A may comprise various components that may be similar to other respective components of the free-form communicative systems 100, 200, and 400 with the communicative system 102 depicted above in FIGS. 1, 2, and 4, without limitations.

Furthermore, in many embodiments, the adaptive communicative system 500 may comprise a variety of different components (or products), such as one or more components that may be both internal- and external-facing and may act together to have a conversation with an end user via the user interface 501. For example, the adaptive communicative system 500 may comprise one or more frontend products, such as, but not limited to, the user interface 501, the DMT 505, the data query layer 507, the bot interfaces 515, and the CEM layer 520.

In some embodiments, a bot user, who is having the conversation with the bot, may interact solely with the bot interface 515. The bot interface 515 may be configured as the chat-style interface in which the bot user may input their message, and then view the response messages that the bot sends back. The bot interface 515 may interact, via the CEM layer 520, with the communicative system 502 that is configured as the main processing unit of the adaptive communicative system 500. In most embodiments, multiple bot interfaces 515 may exist on multiple websites, as one or more users (or clients, customers, etc.) may embed their own unique version of the bot interface 515 if desired. As noted above, each bot interface 515 may interact with the communicative system 502 via the CEM layer 520 that may configured to: (i) handle inbound and outbound event managements, and (ii) wrap the inbound and outbound messages in standardized request and response objects.

In several embodiments, the user interface 501 may be a customer dashboard (or the like) that is configured as a portal for the various users. The user interface 501 may be implemented as a central place used to retrieve scripts for the bot interfaces 515, which may be assigned to a particular user's profile (e.g., this script may be embedded on a user's website, resulting in an adaptive communicative chatbot being available for use by potential bot users on their particular website). Also, in some embodiments, they can also connect a 10-digit mobile phone number to the adaptive communicative system 500 to allow for their consumer's SMS communication with, for example, the communicative system 502 and/or the like. The users may also be able to configure some aspects of the chatbot's processing for aspects that are made available to them, such as customizing their respective company name, location, etc.

In many embodiments, the DMT 505 may be an internal tool configured to: (i) assist developers (e.g., particularly the developers associated with the adaptive communicative system 500), and (ii) allow the developers (or their employees) to create blueprints for a non-technical user. For example, as described below in further detail, a blueprint, such as the blueprint object 518 of FIG. 5B, may be implemented as an assembly of components and policies, which may be configured to define: (i) objects inside of the respective codebase that are taken in by the communicative system 502, and (ii) certain parts of the internal processing of the communicative system 502 when it is responding to inbound messages. In particular, the blueprint may be used to define the behavior of the interpreter engine 516 of FIG. 5B. The DMT 505 may act as a GUI for the developers of the communicative system 502 to modularly create and modify the respective blueprints. In most embodiments, it should be understood that the DMT 505 may not be provided as a user-facing product, as such the DMT 505 may be configured to only acts as an internal tool that is only available to predetermined users (e.g., developers, employees, etc.) associated with the adaptive communicative system 500.

Similarly, for example, the adaptive communicative system 500 may comprise one or more backend products, such as, but not limited to, the communicative system 502, the user pool 503, and the an adaptive conversational database 504. For example, these backend products may be implemented to not have a direct frontend component that is available to the user interface 501 (or the like). In most embodiments, the adaptive conversational database 504 may be a particular database that is used to store particularly generated blueprints loaded for conversation processing, ancillary supporting objects, as well as conversational data. Moreover, in many embodiments, the user pool 503 may be used to store customer-specific data, primarily used for the user interface 501. However, in some embodiments, the user pool 503 may also be referred to by the communicative system 502 in order to add any number of user specifications (or the like) to the backends' processing.

In most embodiments, the communicative system 502 may be configured as the main processing component of the adaptive communicative system 500. For example, the communicative system 502 may be particularly implemented to handle and respond to the bot user's inbound messages, while also factoring in contextual information (e.g., in the form of conversational data, session information, bot configuration, and so on). In several embodiments the Communicative system 502 may be housed as a lambda function (or the like) that may be booted up whenever triggered by an inbound event. For example, this lambda function may return a personalized response object that may be then sent to the corresponding bot interface 515 via the CEM layer 520. Furthermore, as depicted and described in further detail below in FIG. 5B, the communicative system 502 may be configured to process any number and/or types of inbound events/outbound events (or input/output messages), without limitations.

Referring now to FIG. 5B, an exemplary block diagram of the communicative system 502 of the adaptive communicative system 500 is shown, in accordance with an embodiment of the disclosure. In particular, FIG. 5B may be an exemplary illustration of a flowchart depicting various components (and/or logics) of the communicative system 502. As noted above, the communicative system 502 may be configured, but not limited, to: (i) receive an inbound message, (ii) process the inbound event and current contextual information, and (iii) return an outbound message(s). In most embodiments, the communicative system 502 may particularly comprise the main processing phases, including, but not limited to, the processing phases associated with the read engine 510, the processing unit 512, the interpreter engine 516, and/or the generation engine 514. For example, these main processing phases may be implemented specifically to: (i) respond to a bot user's inbound message, and (ii) drive the conversation forward with intentionality and dynamic flexibility.

Furthermore, as shown in FIG. 5B, prior to and after these main processing phases, the communicative system 502 may have several utility functions such as the preprocessing utilities 540 and/or the postprocessing utilities 570 that are being carried out, which may respectively include initially retrieving the relevant (or user-specific) contextual information via the preprocessing utilities 540 (e.g., involved with reading from the database/session), and/or updating the contextual information after the message processing via the postprocessing utilities 570 (e.g., involved with writes to the database/session). Moreover, in most embodiments, the functionality for these main illustrated processing phases implemented by the read engine 510, processing unit 512, interpreter engine 516, and generation engine 514, as well as the functionality for the pre- and post-processing utilities 540 and 570, may be entirely carried out by the communicative system 502.

For example, the preprocessing utilities 540 may include processing, but are not limited to, database reads 560, session retrieval 561, conversation utilities 562, customer attribute utilities 563, retrieve blueprint object 564, retrieve conversation object 565, and/or retrieve customer attributes object 566. Similarly, in another example, the postprocessing utilities 570 may include processing, but are not limited to, conversation utilities 571, customer attribute utilities 572, database writes 573, and/or populate CEM response(s) 574. As such, as noted herein, the communicative system 502 may manage the overarching functions that control the flow of processing from one communicative phase to another phase.

In most embodiments, the communicative system 502 may be particularly configured to: (i) initialize and call any number/types of classes that may correspond to and be needed for each processing phase (or phase of processing), and (ii) provide any ancillary variables that are needed by each class to carry out its processing for that phase. For example, these ancillary variables may include, but are not limited to, a session object, a ledger object, a blueprint object, a conversation object, and/or a customer attributes object. That is, the session object may be configured to contain conversation-level variables and data structures, which may influence the respective processing (or processing phases), and read/modify during different phases of processing as well. The ledger object may be configured to contain a list of the structures that the chatbot may be looking to fill during the conversation, while also managing and tracking the particular structures that have been asked and satisfactorily filled, and the particular value that is used to fill each of the respective structures.

Furthermore, the blueprint object, such as the blueprint object 518, may be configured to process a set of policies and components (or a set of instructions) that may be referenced (particularly by the interpreter engine 516) to determine how to process and respond to a received inbound message, such as the inbound message(s) 530. The conversation object may be configured to record what messages have been received and delivered so far between the bot user and the chatbot, and so on. The customer attributes object may be configured to implement a plurality of objects having various fields and variables that may be made accessible to the users, such that the respective user may be capable of toggling or defining such objects (or fields/variables) in order to modify how the communicative system 502 processes any of the inbound message(s) 530. In several embodiments, theses variables may be made “global” for that entire message cycle, from the inbound message 530 being received to the outbound message(s) 550 being sent back to the bot user.

As noted above, the read engine 510, the processing unit 512, the interpreter engine 516, and the generation engine 516 may be similar to the with the read engine 210, the processing unit 212, the interpreter engine 205, and the generation engine 214 depicted in FIG. 2. In several embodiments, the read engine 510 may be configured to receive the inbound message 530 and then parse any of the grammatical information from that respective inbound message 530 to output one or more read labels 511. For example, the read engine 510 may parse such grammatical information by: (i) using pre-built AllenNLP parsers (or the like) to derive grammatical structures such as constituency/dependency trees, semantic role labelling, etc., and (ii) using said grammatical structures to form the read labels 511, such as the POSTA labels described herein.

The constituency trees and/or the dependency trees associated with the AllenNLP may be used to show how a sentence is broken down into its grammatical components, generally known as syntactic constituents. Some examples of constituents are nouns, verbs, and adjectives, which are referred to as terminal nodes. For example, the AllenAPI constituency tree may show “non-terminal nodes” such as noun phrases that may contain a noun and/or other elements. As such, this information may be used to identify the syntactic function of every word in a particular sentence in a hierarchical fashion. Whereas the dependency trees may identify the relationship between the particular words in a sentence. For example, a verb phrase may contain a head (verb), which might be related to other elements such as adverbs and/or objects. Also, these trees may provide a way to verify that all related elements are grouped into the same category, regardless of the order that they might appear in the sentence “surface” structure. Likewise, the semantic role labelling associated with the AllenNLP may be used to answer important questions about the predicate structure of a sentence. The predicate structure enables a communicative system to better understand important components of sentence meaning, such as who performed an action, who benefitted from the action, and so on.

Furthermore, as described above, the read engine 510 may be configured to read each inbound message 530 in conjunction with using rules based on the outputs of the grammatical parsers, such that the read engine 510 may be capable of classifying the message with a set of particular read labels, such as the POSTA read labels that provide labels for each message related to Person, Object, Sentence Type, Timescope and Action, respectively. Similarly, as described below in further detail in FIGS. 5C-D, the processing unit 512 may be configured to receive and process the read labels 511 to output one or more packages 513. Thereafter, the interpreter engine 516 may be configured to receive and process the packages 513 in conjunction with the blueprint object(s) 518 to generate one or more templates 517 and provide such templates 517 to the generation engine 514.

Referring now to FIG. 5C, an exemplary block diagram of the processing unit 512 of the adaptive communicative system 500 is shown, in accordance with an embodiment of the disclosure. In particular, FIG. 5C may be an exemplary illustration of a flowchart depicting various components (and/or logics) of the processing unit 512 that are configured to process the read labels 511 into the packages 513. As shown in FIG. 5C, the processing unit 512 may include a blocktype engine 519 (or blocktype aggregator) communicatively coupled to a sequence of one or more detectors, which include, but are not limited to: (i) a structure detector(s) 532 associated with a name detector 533, an address detector 534, and one or more additional structure detectors 535; (ii) a general answer detector(s) 542 associated with a number detector 543, a YES/NO/MAYBE detector 544, and one or more additional general answer detectors 545; (iii) a bridge detector(s) 552; and/or (iv) a natural input detector(s) 522 associated with one or more additional natural input detectors 523. As noted above, it should be understood that one or more of the sequence of detectors depicted in FIG. 5C may be similar to the sequence of detectors depicted in FIG. 4.

As shown in FIG. 5C, the read labels 511 (provided by the read engine 510 of FIG. 5B) may be received by the processing unit 512, which may then use, for example, the POSTA labels to further analyze the inbound message, and determine what the inbound message is trying to do and defining that into a set of packages 513. For example, each package 513 may describe, but is not limited to, a blocktype, a structure, a subcategory, a variable(s), and/or a reason. As such, in these embodiments, the processing unit 512 may retrieve the read labels 511 (in addition to one or more other available variables) and then execute the illustrated sequence of detectors in order to generate the packages 513 that are thus forwarded to the interpreter engine 516 of FIG. 5D. For example, once one or more blocktypes have been detected by any of the illustrated detectors of the processing unit 512, the blocktype engine 519 may then format that blocktype(s), as well as other useful information retrieved from any of the illustrated detectors, into the package(s) 513.

In most embodiments, each of the sequence of detectors may have a driver function that may be called (or queried), as well as capable of optionally returning a blocktype or blocktypes. For example, in the event that a blocktype is returned from any of the detectors in the sequence, then the processing unit 512 may stop the sequence of detectors, process the detected blocktype, and thereafter return the resultant package. In some embodiments, the structure detectors 532 may be used to detect various structures that may correspond to different fields of information that the communicative system 502 of FIG. 5A may be trying to fill or get an answer for (e.g., the bot user's address, name, phone number, email, etc.).

Furthermore, the structure detector(s) 532 may implement a set of rules through which the inbound message (and the POSTA read labels 511) are passed, where the set of rules may help determine whether the content of the inbound message is related to any of the predetermined structures. For example, for every structure that is within the communicative system's knowledge, there will be rules that are used to detect whether an inbound message sufficiently fills that structure. Moreover, these rules process the inbound message (i.e., the read labels 511 returned by the read engine 510 of FIG. 5B) and the local conversational information in order to make that detection. For example, the structure detector(s) 532 may (i) call each of the illustrated structure-specific detectors corresponding to various structures that should be detected, and (ii) then synthesizes the outputs of each of those respective detectors into a compiled blocktype or blocktypes that then becomes the outputs of the structure detector(s) 532 as a whole.

Furthermore, in several embodiments, the general answer detector(s) 542 may be used to detect/define any text that could potentially fill multiple structures, at which point other contextual information may be needed to determine what course of conversational action should be taken. Similar to the structure detector(s) 532, the general answer detector(s) 542 may include one or more additional subcategories of general answer detectors, which may be implemented to detect that general answer with their own respective detectors and rules. These rules may also process the inbound message, read labels, and conversational information to make that detection. Meanwhile, the bridge detector 552 may be used for messages that are not particularly associate with any conversation-level content and/or topics, but are instead used in between messages to provide conversational flow, like transitions and so on. For example, in some embodiments, the bridge detector 552 may use a set of rules to process the inbound message and the read labels 511, in order to detect a bridge in the inbound message. If a Bridge is successfully detected, the bridge detector 552 then returns a bridge blocktype to the processing unit 512.

Lastly, as shown in FIG. 5C, the natural input detector(s) 522 may be used to receive the inbound message and then run a similarity check, where it compares the inbound message to a dataset of known natural inputs. For example, a natural input may be defined as a superset of sentences that initialize a detour from the current conversation. These messages are generally prompted by the bot user and are messages that may require a response from the chatbot, for example, in the form of answering a question, handling an objection, and/or dealing with a mistake made by the user or the like.

In most embodiments, the natural input detector(s) 522 may include one or more subcategories of natural inputs, such as, but not limited to: (i) FAQs which are questions asked by the user that the bot needs; (ii) objections which are messages by the user when they are unwilling to answer the bot's questions; and (iii) mistake messages which are messages in which the user wants to change information previously given to the bot. These natural inputs subcategories are detected by taking the inbound sentence, and running one or more similarity check algorithms on the inbound sentence. For example, these similarity checks may operate by applying a GloVe embedding on the inbound message, and then running a Word Mover's Distance algorithm on the GloVe-embedded sentence against a similarly GloVe-embedded dataset. Such dataset may contain a large number of sentences that correspond to the categories and/or subcategories of natural inputs. Furthermore, this similarity check may then return a probability matrix that details how similar the inbound message is to the sentences in the known dataset, in terms of the syntactic function of the words in each sentence. That is, in most embodiments, the probability matrix may allow the natural input detector(s) 522 to then determine the sentence that is closest in meaning to the inbound message, as well as providing a numerical value to denote the level of similarity. This numerical value may be defined as the “distance” from the inbound message to the detected sentence, which is then compared to a predetermined threshold value. If the threshold value is not exceeded, the natural input detector(s) 522 may then determine that a successful match has been found for the inbound message, and thus returns a corresponding natural input blocktype with the corresponding category, and subcategory, of that natural input.

Referring now to FIG. 5D, an exemplary block diagram of the interpretation engine 516 of the adaptive communicative system 500 is shown, in accordance with an embodiment of the disclosure. In particular, FIG. 5D may be an exemplary illustration of one or more process flows 584 and 586 that depict various components (and/or logics) of the interpretation engine 516 configured to process/execute various policies, components, and so on. In most embodiments, the interpretation engine 516 may include, but is not limited to, policies 580, components 581, context objects, message templates 583, policy executor 585, and component executor 587. Furthermore, the interpretation engine 516 may be implemented to receive one or more session(s) and blueprint objects 518 that are associated with the respective inbound message(s) 530 and packages 513.

As shown in FIG. 5D, the interpretation engine 516 may retrieve the packages 513 that have been detected by the processing unit 512 of FIG. 5C, and then refers to a particular blueprint object 518 that may be retrieved from the adaptive conversational database 504 of FIG. 5A. For example, as noted above, the blueprint object 518 may be configured to: (i) define how the communicative system 502 should process each package 513, (ii) what outbound messages should be generated, and (iii) what changes should be made to local conversational variables (the session 515, the ledger etc.). In particular, the interpretation engine 516 refers to the policy set in the blueprint

For example, as shown in the initial process flow 584, the interpretation engine 516 may first initialize one or more context objects 582, and then makes that context object 582 available for reference during the execution of each of the respective policies 580 and components 581. That is, in most embodiments, the interpretation engine 516 may refer to the blueprint object 518 to pull a list of predetermined policies (or applicable policies) from the policies 580, and then determines which of those policies need to be executed for this current message. These determined policies are then added to a policy queue to be executed in order. For example, the execution of each individual policy may involve queueing up the components 581 (or predefined components) defined for each determined policy, and then executing those respective predefined components in order for that determined policy.

Furthermore, in most embodiments, after a policy is executed in completion (i.e., meaning all the components in that policy are either skipped or executed), the next policy in the policy queue may then be executed until the policy queue is empty. At the end of executing all necessary policies and components, what is available and generated is the templates 517 (also referred to as the message templates) that may include a list of outbound message templates (e.g., which correspond to each outbound message) and one or more modified “global” variables. Accordingly, these outbound message templates may then be sent to the generation engine 514 of FIG. 5B to be converted into the personalized outbound messages.

The policies 580 may be defined as a set of policies that provide a set of instructions that are to be executed in order by the interpreter engine 516. For example, a policy may contain any number of components 581, and always at least one. Likewise, the components 581 may be defined as one or more components in a particular policy that is connected in a directed graph and flattened into a one-dimensional list. As such, the policy not only contains all its components, but also defines how those respective components are connected. Each component in that policy has a parent component, at least one child component, and/or both. For example, a policy object defines this sequence of components, such that the interpreter engine 516 may execute those respective components in order.

Policies and Components are analogous to a function and an expression, where a function comprises multiple expressions sequenced in order, and a policy similarly comprises multiple components sequenced in order. A policy may also contain a trigger, which returns a true/false value. Also, whether a policy is to be executed or not is determined by the policy's trigger implemented by the policy executor 585, where this trigger may be defined in the respective blueprint object. For example, the interpreter engine 516 may retrieve a list of policies 580 (or a policy set) from the blueprint object 518, and runs through each policy, determining which policies are to be executed in the current processing cycle. Furthermore, the interpreter engine 516 may evaluate each policy's trigger, executing the policy if the trigger returns true. That is, in some embodiments, policies whose trigger returns a positive true value are added to the policy queue, such that it is possible for any number of policies, or no policies, to be added to the policy queue. Also note, in some embodiments, it is possible for other policies to be triggered later on during the respective processing phase, mainly by certain components which are able to add specific policies to the policy queue. For example, these particular policies may be directly added, without any need to evaluate a trigger; however, on initial loading of the policies, the interpreter engine 516 may only load policies based on the trigger result.

As noted above, the components 581 may be defined as an individual and unique instruction that defines a specific action to be performed. When a particular component is executed by the component executor 587, the interpreter engine 516 then carries out the component's predefined action. Here are some examples of, but not limited to, what a component (or component action) may include: (i) an outbound message template may be generated and queued, which is to then be converted to an outbound message; (ii) an existing “global” variable may be modified (e.g., the ledger is filled, the session 515 is updated, etc.); and (iii) an interpreter-level behavior may be modified by modifying the respective context object (e.g., modifying which policy is executed next, adding another policy to the policy queue, etc.). Furthermore, in several embodiments, the interpreter engine 516 may be configured to process one or more different types of components, including, but not limited to, (1) action components that are used modify variables in the context object; (2) check components that are used to provide conditional logic in the policy execution, by evaluating context variables to determine which component (out of multiple children components) need to execute next; (3) message components that are used to generate outbound message templates which correspond to outbound messages; and (4) utility components that are used to modify variables in the context object, specifically in order to modify the internal behavior of interpreter engine 516. For example, in each component according to most embodiments, there are two or more methods defined, including, but not limited to, (i) what happens when the component is executed, and (ii) which next component in the parent policy should be executed next.

As shown in the second process flow 586, after a component is executed by the component executor 587, the interpreter engine 516 may then determine which component is next to execute (if one exists). For example, the interpreter engine 516 may iterate through the component queue until it finds said child component, such that the child component may then become the current component. For most components, the next component to execute is the one immediately after it in the component queue (e.g., this is usually the current component's child component, as defined in that particular blueprint). However, for some components, there are multiple children components defined in that blueprint. For such components, there is functionality defined where the interpreter engine 516 may evaluate certain variables in the context object, and then determine which of the multiple children's components is the next to be executed. Lastly, the interpreter engine 516 may then loop through the component queue until this next component is found, and then executes it.

In most embodiments, the context object(s) 582 may provide a “local state” that is referred to during the processing of the current message. For example, a context object may include variables that might determine what specific actions are carried out. As such, the context object may be initialized at the start of processing, and then made available for reference during the execution of every policy and component. Here are some example of particular objects that may exist in the context object is: a session, a list of packages, a blueprint object, a template queue where the outbound message templates may be held, a policy queue where policies are queued for execution, a component queue where components for each policy are queued for execution, a policy variables object where these objects may be used within the execution of a particular policy and/or for variables that need to be passed from one component to another, and/or a context flags object where a set of Boolean variables may be used to toggle certain behaviors. For example, these context objects 582 may be made available during the execution of each policy and component, such that every component then refers to the variables in the context object during execution, and in some cases, modifies certain variables in the context object.

Lastly, in most embodiments, the template(s) 517 may include one or more message templates that are each defined as a data structure containing enough information for the generation engine 514 of FIG. 5B to generate an outbound message. For example, a filled message template may include, but is not limited to, a string literal that optionally contains variable names, and a dictionary mapping variable names to context-specific values that are meant to replace the variables in the string literal. In these embodiments, the message templates are populated during the execution of the respective message components. For example, the definitions for these message templates are defined in the respective blueprint and/or in a message component set. That is, when a message component is executed, the interpreter engine 516 may refer to the blueprint's message component set, and then finds the corresponding message template definition for the current message component. For example, in some embodiments, the message template definition may only include the string literal. Then, if there are any variable names defined in the string literal, the interpreter engine 516 may derive the correct context-specific values from the context object, and adds those to the message template respectively, such that the filled message template is then added to the template queue in the context object. Accordingly, as noted above, the templates 517 are then received by the generation engine 514 of FIG. 5B.

In most embodiments, the generation engine 514 of FIG. 5B may then take in a template queue, containing a list of message templates from the interpreter engine 516, and then converts these to personalized outbound messages, in the form of strings. As described above, in many embodiments, the generation engine 514 may be particularly used to: (i) take each message template, and (ii) replace the variable names in the string literal with the correct context-specific value. When the generation engine 514 encounters a variable name embedded in the string literal, the generation engine 514 may then refer to the dictionary in the message template that maps variable names to context-specific values. Thereafter, in most embodiments, the generation engine 514 may then find the correct context-specific value for the encountered variable name, and thereby replaces the variable in the string literal with the context-specific value. Lastly, at the end of processing each message template, what is left is a string that has been filled with the relevant context-specific information (i.e., this is an individual personalized outbound message). Also note, that in some embodiments after having processed every message template in the template queue, the generation engine 514 may then be left with a list of outbound messages, which it then returns to the communicative system 500 to be sent back to the bot user.

Referring now to FIG. 6, an exemplary block diagram of a distributed communicative system 600 is shown, in accordance with an embodiment of the disclosure. In embodiments, the distributed system 600 includes one or more client computing devices 601, 602, 604, 606, and 608 configured to execute and operate a client computer program or application, such as a web browser, proprietary client, or the like, over one or more network(s) 610. The server 612 may be communicatively coupled with the client computing devices 601, 602, 604, 606, and 608 via network 610. For example, any of the client computing devices 601, 602, 604, 606, and 608 in FIG. 6 may be similar to the mobile device 170 depicted in FIG. 1.

In embodiment, the server 612 may be implemented to run one or more communicative services or software applications provided by one or more of the components of the system. The communicative services or software applications may include nonvirtual and virtual environments. Virtual environments may include those used for virtual events, tradeshows, simulators, classrooms, shopping exchanges, and enterprises, whether two-dimensional (2d) or three-dimensional (3D) representations, page-based logical environments, or the like. In some embodiments, these services may be offered as web-based or cloud services or under a Software as a Service (SaaS) model to the users of the client computing devices 601, 602, 604, 606, and/or 608. The users of the client computing devices 602, 604, 606, and/or 608 may in turn use one or more client applications to interact with the server 612 and utilize the services provided by these components.

In the embodiments shown in FIG. 6, the communicative components 618, 620 and 622 are shown as being implemented on the server 612, where these components 618, 620, and/or 622 may be implemented as free-form communicative systems (or the like). In other embodiments, one or more of the communicative components 618, 620 and 622 and/or the applications or services provided by the communicative components 618, 620 and 622 may also be implemented by one or more of the client computing devices 601, 602, 604, 606, and/or 608. The users operating the client computing devices may then utilize one or more client applications to use the applications and/or services provided by these components. The communicative components 618, 620 and 622 may be implemented in hardware, firmware, software, or combinations thereof. It should be understood that various different system configurations may be utilized without limitation.

The client computing devices 601, 602, 604, 606, and/or 608 may be any type of interactive computing devices. For example, client computing devices may include portable handheld devices (e.g., a mobile device, a cellular telephone, a mobile or cellular pad, a computing tablet, a personal digital assistant (PDA)), wearable devices (e.g., a head mounted display), one or more widely-used running software and/or mobile operating systems, or any other interactive enabled devices. The client computing devices may be personal computers and/or laptop computers running various operating systems. The client computing devices may be workstation computers running any variety of commercially available operating systems. Alternatively, the client computing devices may be any other electronic device, such as a thin-client computer, an Internet-enabled gaming system (e.g., a gaming console with a messaging input device), and/or a personal messaging device that is capable of communicating over the network 610. Although five client computing devices are shown, it is to be understood that any number of client computing devices may be utilized without limitation.

The server 612 may be configured as personalized computers, specialized server computers (including, by way of example, PC (personal computer) servers, mid-range servers, mainframe computers, rack-mounted servers, etc.), server farms, server clusters, or any other appropriate arrangement and/or combination. The server 612 may include one or more virtual machines running virtual operating systems, or other computing architectures involving virtualization. One or more flexible pools of logical storage devices may be virtualized to maintain virtual storage devices for the server 612. Virtual networks may be controlled by the server 612 using software-defined (or cloud-defined) networking. In embodiments, the server 612 may be configured to run one or more communicative programs or services or software applications described herein. For example, the server 612 may be associated with a server implemented to perform the process 300 described above in FIG. 3, in accordance with embodiments of the present disclosure. The server 612 may implement one or more additional server applications and/or mid-tier applications, including, but are not limited to, hypertext transport protocol (HTTP) servers, file transfer protocol (FTP) servers, common gateway interface (CGI) servers, database servers, and/or the like.

The distributed system 600 may also include one or more databases 614 and 616. The databases 614 and 616 may reside in a variety of locations. By way of example, one or more of databases 614 and 616 may reside on a non-transitory storage medium local to (and/or resident in) the server 612. Alternatively, the databases 614 and 616 may be remote from the server 612 and in communication with the server 612 via a network-based or dedicated connection. In some embodiments, the databases 614 and 616 may reside in a SAN. Similarly, any necessary files for performing the functions attributed to the server 612 may be stored locally on the server 612 and/or remotely (if appropriate). In other embodiments, the databases 614 and 616 may include relational databases that are adapted to store, update, and retrieve data in response to SQL-formatted commands.

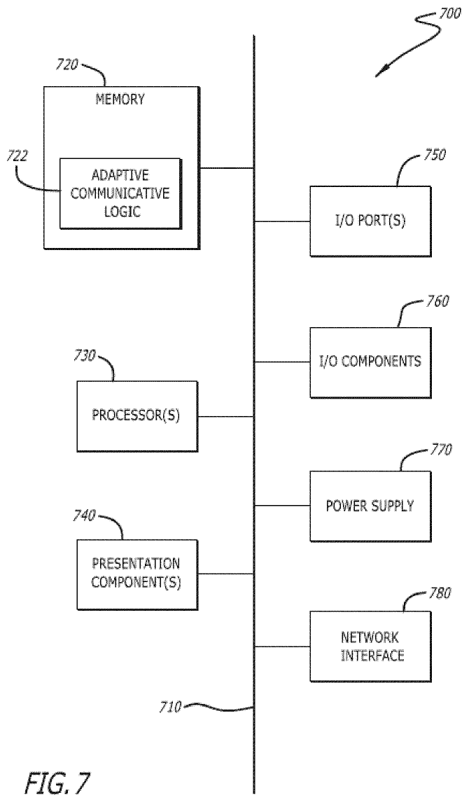

Referring now to FIG. 7, an exemplary schematic of a computer system 700 is shown, in accordance with an embodiment of the disclosure. The computing system 700 in FIG. 7 is one example of a suitable computing environment and is not intended to suggest any limitation as to the scope of use or functionality of the embodiments of the disclosure. Additionally, it should be understood that the computing system (or device) 700 may not be interpreted as having any dependency or requirement relating to any one or combination of components described or illustrated herein.

In embodiments, the computing system 700 includes a bus 710 that directly or indirectly couples the following devices: a memory 720 with adaptive communicative logic 722, one or more processors 730, one or more presentation components 740, one or more input/output (I/O) ports 750, one or more I/O components 760, and an illustrative power supply 770. The bus 710 represents what may be one or more busses (such as an address bus, data bus, or a combination thereof). The computing system 700 may include a variety of computer-readable media. Computer-readable media may be any available media that may be accessed by the computing system 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The memory 720 may include computer storage media in the form of volatile and/or nonvolatile memory. The memory 720 may be removable, non-removable, or a combination thereof. Exemplary memory includes solid-state memory, hard drives, optical-disc drives, etc. The computing system 700 may include one or more processors 730 that read data from various entities such as the bus 710, memory 720, or I/O components 760. The presentation components 740 may present data indications to users or other devices. Exemplary presentation components 740 include a display device, speaker, printing component, vibrating component, etc. The I/O ports 750 may allow the computing device 700 to be logically coupled to other devices, including the I/O components 760, some of which may be built in.

In various embodiments, the memory 720 includes, in particular, temporal and persistent copies of adaptive communicative logic 722. The adaptive communicative logic 722 may include instructions that, when executed by one or more processors 730, result in the computing system 700 performing various functions, including, but not limited to, the process 300 of FIG. 3 and/or any other processes described herein in relation to FIGS. 1-6.

In some embodiments, one or more processors 730 may be packaged together with the adaptive communicative logic 722. In some embodiments, one or more processors 730 may be packaged together with the adaptive communicative logic 722 to form a System in Package (SiP). In some embodiments, one or more processors 730 may be integrated on the same die(s) with the adaptive communicative logic 722. In some embodiments, the processors 730 may be integrated on the same die(s) with the adaptive communicative logic 722 to form a System on Chip (SoC).

The I/O components 760 may include a microphone, joystick, gamepad, satellite dish, printer, display device, wireless device, a controller (e.g., a stylus, a keyboard, and a mouse), a natural user interface (NUI), and/or the like. In some embodiments, a pen digitizer (not shown) and accompanying input instrument (also not shown but which may include, by way of example only, a pen or a stylus) are provided in order to digitally capture free-form user input. The connection between the pen digitizer and processor(s) 730 may be direct or via a coupling utilizing a serial port, parallel port, and/or other interface and/or system bus known in the art. Furthermore, the digitizer input component may be a component separated from an output component such as a display device, or in some embodiments, the usable input area of a digitizer may coexist with the display area of a display device, be integrated with the display device, or may exist as a separate device overlaying or otherwise appended to a display device.

The computing system 700 may use the networking interface 780 that includes a network interface controller (NIC) that transmits and receives data. The networking interface 780 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 780 may include a wireless terminal adapted to receive communications and media over various wireless networks. The computing system 700 may communicate via wireless protocols, such as Code Division Multiple Access (CDMA), Global System for Mobiles (GSM), or Time Division Multiple Access (TDMA), as well as others, to communicate with other devices via the networking interface 780. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using one or more of CDMA, GPRS, GSM, TDMA, and 802.16 protocols.

Information as shown and described in detail herein is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail may be made, without departing from the spirit and scope of the present disclosure, as set forth in the appended claims, as might be apparent to those of ordinary skill in the art, are also encompassed by the present disclosure.

What is claimed is:

1. A method of personalizing a free-form communicative system, comprising:
receiving an inbound message from a communicative interface;
acquiring a plurality of labels from a read engine based on the inbound message;
detecting one or more blocktypes with a processing unit based on the inbound message and the plurality of labels;
populating a plurality of packages with the processing unit based on the inbound message and the one or more detected blocktypes;
generating a template queue with an interpreter engine based on a blueprint object used to process each of the plurality of populated packages, wherein the blueprint object comprises a list of predetermined policies and a plurality of defined components;
receiving personalized sentences from a generation engine based on a list of message templates ascertained from the generated template queue; and
sending an outbound message to the communicative interface based on the personalized sentences, wherein the outbound message is a natural language response.

2. The method of claim 1, wherein the plurality of labels are comprised of at least one or more of person labels, object labels, sentence type labels, timescope labels, and action labels.

3. The method of claim 1, wherein the plurality of labels are associated with one or more dependency trees.

4. The method of claim 3, wherein the one or more detected blocktypes are aggregated based on at least one or more of the inbound message, the plurality of labels, and the one or more dependency trees.

5. The method of claim 1, further comprising:
initializing and calling one or more classes via an adaptive communicative application, wherein the initialized and called classes correspond to one or more phases that are processed by at least one or more of the read engine, the processing unit, the interpreter engine, and the generation engine; and
providing one or more ancillary variables via the adaptive communicative application to each of the initialized and called classes, wherein the one or more provided ancillary variables are used by each of the initialized and called classes to respectively carry out the one or more processed phases.

6. The method of claim 5, wherein the one or more provided ancillary variables comprise at least one or more of a session object, a ledger object, the blueprint object, a conversation object, and a customer attributes object.

7. The method of claim 1, wherein the processing unit further comprises a sequence of one or more detectors.

8. The method of claim 7, wherein the sequence of one or more detectors comprise at least one or more of a structure detector, a general answer detector, a bridge detector, and a natural input detector.

9. The method of claim 1, wherein the blueprint object is retrieved from a specialized database used to store a plurality of generated blueprints, and wherein the plurality of generated blueprints are implemented for at least one or more of adaptive conversational processing phases, ancillary supporting objects, and conversational data.

10. The method of claim 9, wherein the blueprint object further defines: (i) how the interpreter engine particularly processes each of the plurality of packages, (ii) what particular outbound messages are generated based on each of the respective processed packages, and (iii) what particular changes are made to at least one or more local conversational variables and the one or more ancillary variables.

11. The method of claim 1, wherein the plurality of defined components comprise at least one or more of action components, check components, message components, and utility components.

12. A communicative system, comprising:
one or more processors; and
a non-transitory computer-readable medium for storing instructions that, when executed by the one or more processors, cause the one or more processors to:
receive one or more inbound messages from a communicative interface;
initialize and call one or more classes via an adaptive communicative application, wherein the initialized and called classes correspond to one or more phases that are processed by at least one or more of a read engine, a processing unit, an interpreter engine, and a generation engine;
provide one or more ancillary variables via the adaptive communicative application to each of the initialized and called classes, wherein the one or more provided ancillary variables are used by each of the initialized and called classes to respectively carry out the one or more processed phases;
acquire a plurality of labels from the read engine based on the inbound messages;
detect one or more blocktypes with the processing unit based on the inbound messages and the plurality of labels;
populate a plurality of packages with the processing unit based on the inbound messages and the one or more detected blocktypes;
generate one or more template queues with the interpreter engine based on one or more blueprint objects used to process each of the plurality of populated packages, wherein each of the blueprint objects comprises a list of predetermined policies and a plurality of defined components;
receive personalized sentences from the generation engine based on a list of message templates ascertained from the generated template queues; and
send one or more outbound message to the communicative interface based on the personalized sentences, wherein the outbound messages are natural language responses.

13. The communicative system of claim 12, wherein the plurality of labels are comprised of at least one or more of person labels, object labels, sentence type labels, timescope labels, and action labels, and wherein the plurality of labels are associated with one or more constituency trees and one or more dependency trees.

14. The communicative system of claim 13, wherein the one or more detected blocktypes are aggregated based on at least one or more of the inbound message, the plurality of labels, and the one or more dependency trees.

15. The communicative system of claim 12, wherein the one or more provided ancillary variables comprise at least one or more of a session object, a ledger object, the blueprint object, a conversation object, and a customer attributes object.

16. The communicative system of claim 12, wherein the processing unit further comprises a sequence of one or more detectors.

17. The communicative system of claim 16, wherein the sequence of one or more detectors comprise at least one or more of a structure detector, a general answer detector, a bridge detector, and a natural input detector.

18. The communicative system of claim 12, wherein the blueprint object is retrieved from a specialized database used to store a plurality of generated blueprints, and wherein the plurality of generated blueprints are implemented for at least one or more of adaptive conversational processing phases, ancillary supporting objects, and conversational data.

19. The communicative system of claim 18, wherein the blueprint object further defines: (i) how the interpreter engine particularly processes each of the plurality of packages, (ii) what particular outbound messages are generated based on each of the respective processed packages, and (iii) what particular changes are made to at least one or more local conversational variables and the one or more ancillary variables.

20. The communicative system of claim 12, wherein the plurality of defined components comprise at least one or more of action components, check components, message components, and utility components.
